(19) United States
(12) Patent Application Publication
(10) Pub. No.: US 2008/0123966 A1
(43) Pub. Date: May 29, 2008

(54) Image Processing Apparatus

(76) Inventors: Toshio Nishida, Yokohama (JP); Hiroshi Chiba, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/945,472

(22) Filed: Nov. 27, 2007

(30) Foreign Application Priority Data
Nov. 27, 2006 (JP) 2006-317955

(51) Int. Cl. G06K 9/46; H04N 5/225

(52) U.S. Cl. 382/203; 348/207.1

(57) ABSTRACT

According to the present invention, it is possible to improve the usability of an automatic image editing apparatus by finding subject-captured scenes from inter-frame motion vectors for automatic editing of motion images. If the result of analyzing inter-frame motion vectors indicates that all motion vectors in a region are the same in direction and magnitude, this region is judged as a subject being followed. Thus, it is possible to automatically extract and edit subject-captured scenes. In addition, the edited images namely plural scenes may be displayed either in the same order as edited or in the order of importance. As well, similar scenes may be combined into a single image sequence. Thus, it is possible to provide improved usability to the viewer.

### CLAIM OF PRIORITY

The present application claims priority from Japanese application no. JP 2006-317955, filed on Nov. 27, 2006, the content of which is hereby incorporated by reference into this application.

### BACKGROUND OF THE INVENTION

(1) Field of the Invention

The present invention relates to an image processing apparatus capable of automatically editing motion images.

(2) Description of the Related Art

As the background of this technical field, various techniques have been proposed.

One example is JP-A-2002-176613. In this document laid open, “providing an apparatus which automatically edits motion images” is mentioned as an object. As well, “a motion image processing apparatus where a plurality of motion image files 142 are recorded on a fixed disk 104, comprising a judge section 21, extract section 23 and a combine section 24, wherein: parts of motion image sequences whose image or sound signals respectively meet certain criteria, such as a part where a specific person's face is included, a part which was recorded with a subject zoomed in and a part where the magnitude of sound exceeds a certain level, are identified by the judge section 21; partial motion image sequences which respectively include the identified parts are extracted from the motion image files 142 by the extract section 22; and an edited file 143 is created by the combine section 23 by combining the partial motion image sequences, which realizes automatic edit of motion images” is disclosed therein as a solution.

Another is JP-A-2005-318180. In this document laid open, “making it possible to automatically set chapters during dubbing as intended by the user without no operation” is mentioned as an object. As well, “allowing the user to specify where to set chapters by inserting still images while taking a motion image sequence by a digital video camera; and setting a chapter if a still image is found while the motion image sequence taken by the camera is dubbed into a hard disk recorder wherein an MPEG encoder of the recorder compresses the image data at a variable bit rate and, if this bit rate continues to be lower than a threshold for a certain period of time, the image is judged as a still image” is disclosed as a solution.

### SUMMARY OF THE INVENTION

With the progress of recording media in capacity, recent video cameras and the like can perform long-time motion image recording. In addition, software is available to allow a personal computer or the like to take in and edit motion images to generate and record a new motion image sequence. In this editing operation, however, the user must perform an audio-visual check in order to determine which scenes should been recorded. To edit a long motion image sequence, it is inevitable to spend great amounts of energy and time.

Therefore, techniques have been proposed to enable automatic editing of motion images.

For example, one technique is to perform automatic editing based on the camera attitude data, exposure data, zoom factor data, subject distance data and other image pickup environment information recorded together with images. Another technique is to extract specific scenes from a recorded image sequence. For example, it is possible to extract scenes where the face of a certain person appears and scenes where the magnitude of sound exceeds a reference level. Similarly, it is also proposed to automatically cut a scene if quick pan, tilt or zoom was done to shoot the scene. Such scenes are considered uncomfortable to viewers. For video cameras, it is proposed to insert still images as appropriate during shooting as a method for facilitating editing. During editing, chapters are set automatically based on the image bit rate.

By using these automatic editing techniques, it is possible to keep necessary scenes only. However, great amounts of image data result in large amounts of edited images. This means that the usability is raised if the edited images are presented not simply in the same order as they were edited but, for example, in the order of importance for the viewer.

It is an object of the present invention to improve automatic image editing apparatus in usability.

According to a representative aspect of the present invention, an automatic image editing apparatus is configured so that subject-captured scenes are found from inter-frame motion vectors for automatic editing of motion images. Specifically, the above-mentioned object can be attained by the invention covered by the appended claims.

According to the present invention, there is provided an automatic image editing apparatus improved in usability.

Note that the above-mentioned and other objects, means and effects will become apparent from the following description of embodiments.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a first image processing system embodiment of the present invention.

FIGS. 2A and 2B show an exemplary result of image analysis implemented by the first image processing system embodiment of the present invention.

FIG. 3 is a block diagram showing a second image processing system embodiment of the present invention.

FIGS. 4A and 4B show exemplary arrays of edited images displayed in thumbnail form by the second image processing system embodiment of the present invention.

FIG. 5 is a block diagram showing a third image processing system embodiment of the present invention.

FIG. 6 is a block diagram showing a third image processing system embodiment of the present invention.

FIG. 7 is a block diagram showing a fourth image processing system embodiment of the present invention.

FIG. 8 is a block diagram showing a fourth image processing system embodiment of the present invention.

### DETAILED DESCRIPTION OF THE EMBODIMENT

With reference to the drawings, embodiments of the present invention will be described below.

### Embodiment 1

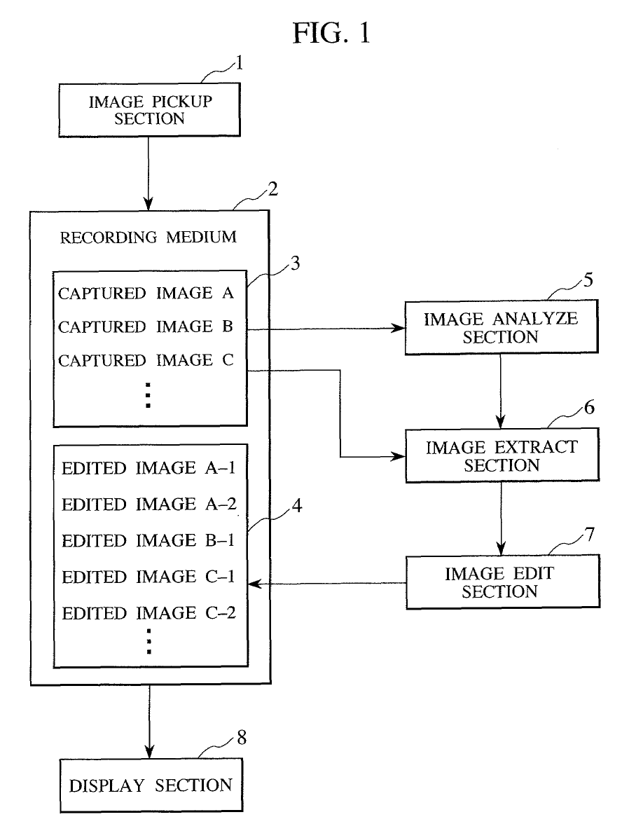

FIG. 1 is a block diagram of a first image processing system embodiment of the present invention, showing how motion images are automatically edited therein. Shown here is an example of the present image processing system applied to a vide camera. In FIG. 1, reference numeral 1 denotes a image pickup section; 2 denotes a recording medium; 3 denotes shot images recorded on the recording medium 2; 4 denotes edited images produced by automatic editing of shot images 3; 5 denotes an image analyze section; 6 denotes an image extract section; 7 denotes an image edit section; and 8 denotes a display section. The shot images 3 comprise shot images A˜C which respectively denote individual shot image files. Each of these image files can be accessed separately. Likewise, the edited images 4 comprise edited images A-1˜C-2 which respectively denote individual edited image files. Each of these edited image files can also be accessed separately. Here, access means recording and/or reproducing to and/or from the recording medium. Note that access to the recording medium is performed by a recording and reproducing section which is not shown in the figure and whose description is omitted below.

Images, which are shot by a vide camera, are stored in the recording medium 2 as shot images 3. To automatically edit the shot images, each shot image file of the shot images 3 is put to image analysis by the image analyze section 5 at first. Then, based on the result of this analysis, scenes to be kept are extracted from each shot image file of the shot images 3 by the image extract section 6. The extracted scenes are stored again in the recording medium 2 as edited images 4 by the image edit section 7. The stored edited images 4 are reproduced in the display section 8. Note that edited images A-1 and A-2 of the edited images 4 mean scenes 1 and 2 which are extracted respectively from shot images A of the shot images 3.

The processing of the image analyze section 5 will be described. In the image analyze section 5, motion vectors in shot images 3 are determined by analyzing inter-frame motion information as described below in detail with reference to a specific example.

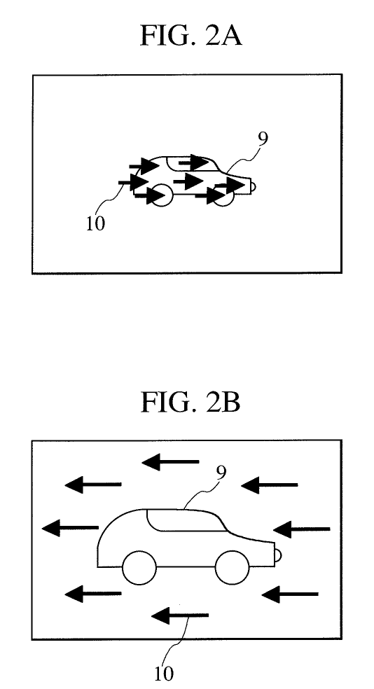

FIGS. 2A and 2B schematically show results of shot images of a moving vehicle processed by the image analyze section 5. In the same drawings, reference numeral 9 denotes the subject vehicle 9 and 10 denotes a motion vector. The image in FIG. 2A is obtained by shooting the subject 9 from a distance whereas the image in FIG. 2B is obtained while panning a camera to follow the subject 9 zoomed in. In the case of FIG. 2A, since the subject 9 is moving alone in the shot images, motion vectors appear thereon. If the subject 9 is rigid, these motion vectors are the same in direction and magnitude. In the case of FIG. 2B, since the image is taken by following the subject 9, motion vectors appear not on the subject 9 but in the background thereof. Although the motion vectors appearing on the subject 9 are as small as almost “0” in magnitude, they are the same in direction and magnitude like in FIG. 2A. Therefore, each scene in which the subject 9 is captured can be extracted by analyzing motion vectors in the shot images and extracting a scene if the scene includes an area where motion vectors are the same in direction and magnitude.

Specifically, scenes are not extracted unless the captured subject 9 is larger than a certain size. This intends to avoid extracting scenes where the captured subject is small because it is preferable that the subject be well captured in the scenes which constitute the edited images 4. A criterion for this judgment is set for each shot image file of the shot images 3. For example, the method for determining the judgment criterion may be: detecting a frame where the captured subject 9 has the largest size; measuring the size of the subject in the frame; and setting the half of the size as the judgment criterion. In this method, scenes are extracted only if the subject 9 is captured therein and its size exceeds the criterion.

Although image analysis of shot images is done after stored in the recording medium in the present embodiment, this configuration may be modified so that shot images are immediately analyzed and recorded together with an analysis result and then image extraction is performed by using this analysis result as information for extraction. In addition, although the present embodiment is configured so as to store edited images in the recording medium before output to the display section, this configuration may be modified so as to directly output edited images to the display section. As well, the image extract section 6 may be configured so as to add a certain margin to the front and rear of each scene decided to be extracted based on the result of analysis by the image analyze section 5. If no margin is added for extraction, the edited images 4 do not include scenes where the subject 9 was partly captured in the angular field of view of the camera. If a scene is extracted with margins, the scene starts with the subject 9 being framed in and ends with the subject 9 being framed out.

### Embodiment 2

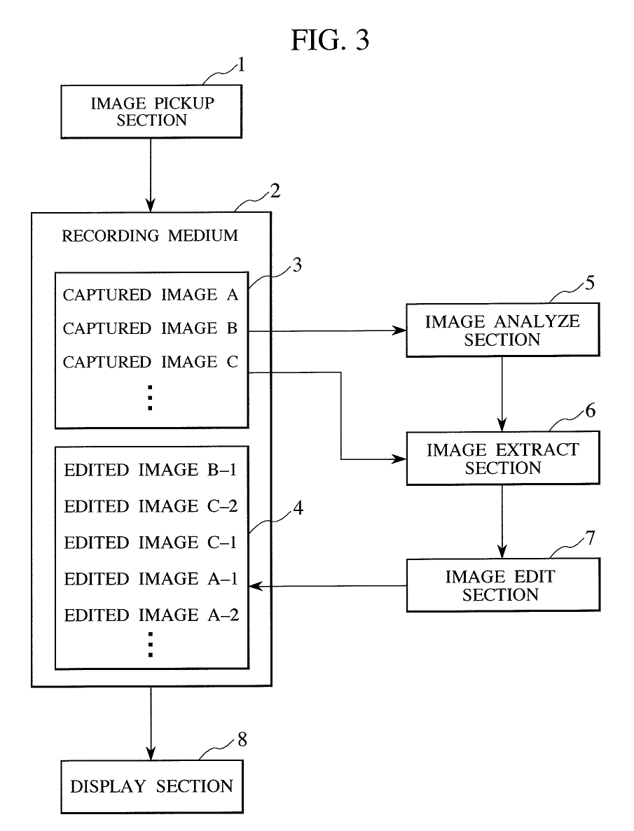

FIG. 3 is a block diagram of a second image processing system embodiment of the present invention, showing how motion images are automatically edited therein. As compared with FIG. 1 showing a block diagram of the first embodiment of the present invention, the edited image files of the edited images 4 are stored in a different order.

If the shot images 3 are huge in quantity, the edited images 4 to be produced by editing extracted scenes will also become huge in quantity although the scenes to be extracted are limited to necessary ones. This situation imposes a burden on the person who reviews the edited images 4. Therefore, the image edit section 7 stores the edited images 4 not simply in the same order as they were edited but in the order of importance so that they can be reviewed more effortlessly.

For example, consider FIGS. 2A and 2B. Although both are results of analyzing images of a vehicle, FIG. 2A was shot from a distance while the vehicle in FIG. 2B is zoomed in. Zooming in a subject means that the cameraman shoots the scene with attention to the subject. Therefore, if a scene is shot with a larger zoom factor, this scene can be regarded as more important. Accordingly, the image analyze section 5 performs not only analysis but also weighting in consideration of the zoom factor. The image edit section 7 stores edited images in the recording medium 2 in the order determined by itself based on the weighting information. As described below, the display section 8 may be configured so as to display a list of edited image files in thumbnail form when the stored edited images 4 are reviewed.

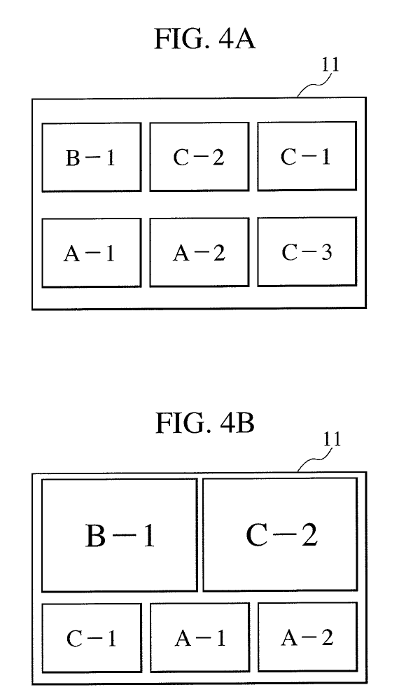

In each of the examples shown in FIGS. 4A and 4B, edited image files are displayed in thumbnail form. In FIG. 4A, edited images files are displayed in thumbnail form in the same order as the storage order determined according to the weighting information. In FIG. 4B, although edited image files are displayed in the same order as in FIG. 4A, the most important ones are given a larger area. Note that although file names are shown there for the purpose of simplicity, the actual screen displays the top frame image of each edited image file in thumbnail form.

The following describes the method of determining the zoom factor selected for each image. If motion vector information from the image analyze section 5 indicates that all vectors in a region are the same in direction and magnitude, it is possible to judge that this region represents the subject. Therefore, if this region occupies a larger part of the whole image, it can be considered that a larger zoom factor was selected. Alternatively, it is also possible to use zoom factor information obtained during shooting.

The present embodiment provides improved usability to the viewer by changing the storage order of the edited images 4. However, it is not inevitable for this method to change the storage order. For example, if edited images are stored together with their degrees of importance as additional information, they can be displayed in the order of importance determined by referring to the additional information. As well, although zoom factors are used for weighting by importance in the above description, weighting may also be done, for example, by the type of the subject such as a certain figure, animal, vehicle or the like or by the length of time for which the subject is captured.

### Embodiment 3

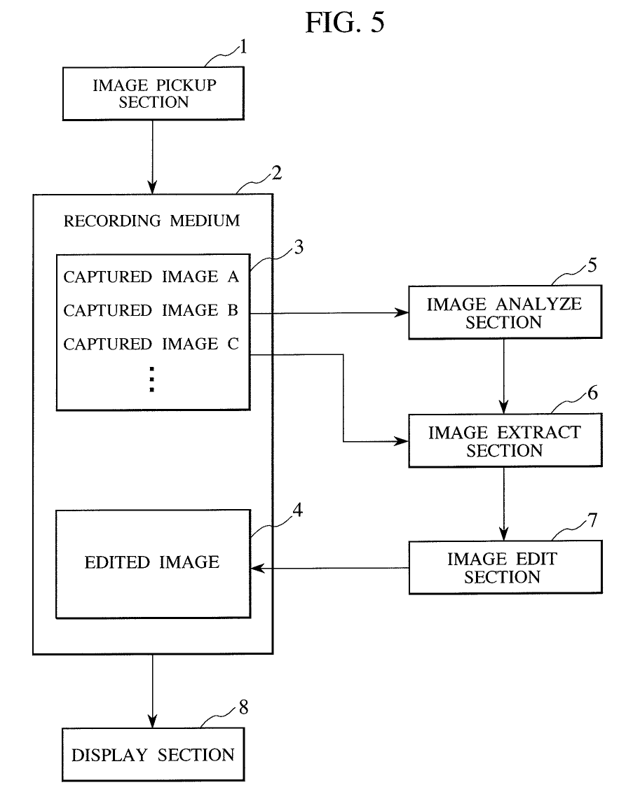

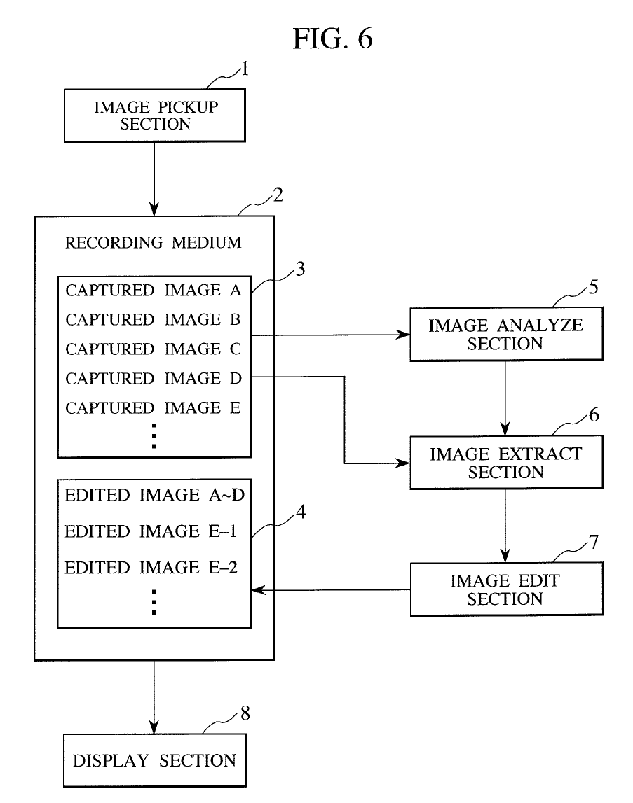

FIGS. 5 and 6 are block diagrams of third image processing system embodiments of the present invention, showing how motion images are automatically edited therein. As compared with FIG. 1 showing a block diagram of the first embodiment of the present invention, the edited image files constituting the edited images 4 are organized differently.

As in the second embodiment, if the shot images 3 are huge in quantity, the edited images 4 to be produced by editing extracted scenes will also become huge in quantity although scenes are selectively extracted. This situation imposes a burden on the person who reviews the edited images 4. Therefore, the image edit section 7 combines a plurality of scenes into a single image sequence so that they can be reviewed more effortlessly.

For example, this arrangement may be done by utilizing zoom factors selected in shooting images. Zooming in a subject means that the cameraman shoots the scene with attention to the subject. In contrast, some images are shot without zooming in a subject since the cameraman may intend to capture both the subject and the background. Accordingly, zoom factor information may be used to sort images by content into such groups as a group of subject-featured scenes and a group of landscape scenes. By using shooting time information, images may also be grouped on the basis of time, namely by month, week, day and the like. FIGS. 5 and 6 show examples of such editing.

In FIG. 5, all scenes extracted by the image extract section 6 are combined into a single image sequence for storage by the image edit section 7. These scenes need not be combined in the same order as edited. In FIG. 6, the images extracted from shot image files A˜D are combined into a single image sequence since they were judged as scenes of the same kind. Two scenes E-1 and E-2, extracted from shot image file E, are stored separately without being combined since they were judged as scenes of different kinds. In this manner, it is possible to store both combined ones and uncombined ones.

### Embodiment 4

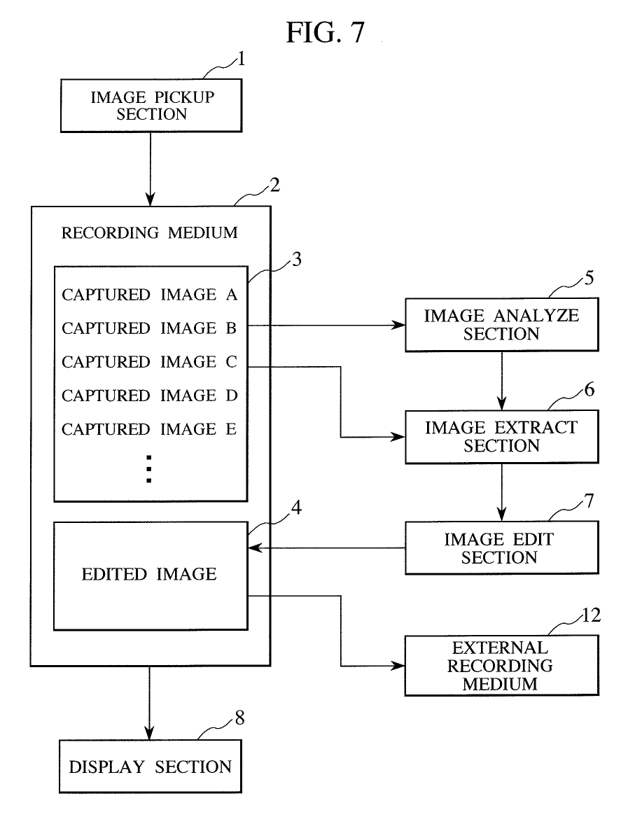

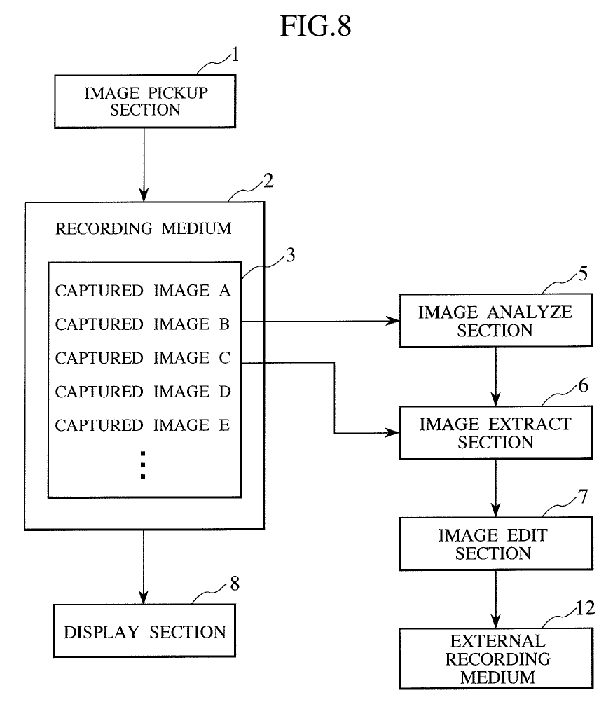

FIGS. 7 and 8 are block diagrams of fourth image processing system embodiments of the present invention, showing how motion images are automatically edited therein. As compared with FIG. 1 showing a block diagram of the first embodiment of the present invention, FIGS. 7 and 8 are unique in that the images edited by the image edit section 7 are stored in an external storage medium 12. In FIG. 7, the images edited by the image edit section 7 is once stored in the recording medium 2 before copied or moved to the external recording medium 12. In FIG. 8, the images edited by the image edit section 7 are directly stored to the external recording medium 12. For example, if a video camera is thus configured, the image data recorded in the internal recording medium such as a HDD or DVD drive, after edited automatically, can be copied or moved to another internal recording medium such as a HDD or DVD drive or to an externally attached recorder, personal computer, etc.

The image analyze section 5, image extract section 6 and image edit section 7 in each above-mentioned embodiment may be implemented as separate LSIs which respectively operate as these sections or as one or more LSIs which are partly or wholly shared to them. It is also possible to configure them by a cooperative combination of hardware (CPU or the like) and software stored in memory to implement the aforementioned operations.

In addition, although it is assumed in the description of each embodiment that the image analyze section 5 determines motion vectors by analyzing inter-frame motion information, image analysis is not limited to this method. For example, if shot images 3 are compressed/encoded by the MPEG scheme, it is possible to use motion vectors which are determined in the process of this compression encoding and stored in association with respective frames. In this case, a compression encoding section is between the image pickup section 1 and the recording medium 2. The shot images from the image pickup section 1 are compressed/encoded by this compression encoding section not shown in the figures and the compressed/encoded shot images are recorded in the recording medium 2 by a record and playback section not shown in the figures. This configuration may also be employed with any other compression encoding scheme which determines motion vectors by utilizing inter-frame correlation.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

The present invention is applicable to video cameras, recorders, monitor systems and other systems which treat huge amounts of image data.

What is claimed is:

1. An image processing apparatus comprising:
a recording section that records one or more motion image sequences;
an image analyze section that analyzes the motion image sequences;
an image extract section that extracts specific scenes based on the result of analysis by the image analyze section;
an image edit section that edits the scenes extracted by the image extract section; and,
a display section that displays the images edited by the image edit section;
wherein the image extract section extracts scenes where a subject is captured and the captured subject is larger than a certain size.

2. An image processing apparatus according to claim 1 wherein,
the image analyze section uses motion vectors for extracting where a subject is captured and the captured subject is larger than a certain size.

3. An image processing apparatus according to claim 1 wherein,
the image extract section adds a certain margin to the top and end of a scene to be extracted.

4. An image processing apparatus according to claim 1 wherein,
one or more scenes extracted by the image extract section are edited respectively by the image edit section as one or more image sequences that can be accessed separately.

5. An image processing apparatus according to claim 1 wherein,
two or more scenes extracted by the image extract section are combined by the image edit section so that the two or three scenes can be accessed as a single image sequence.

6. An image processing apparatus according to claim 4 wherein,
the image edit section gives to each of the scenes extracted by the image extract section a weight according to the degree of zoom in so that the scenes can be accessed in the decreasing order of weights.

7. An image processing apparatus according to claim 4 wherein,
the display section changes the menu to be displayed according to the degrees of importance of image sequences edited by the image edit section.

8. An image processing apparatus according to claim 4 wherein,
the image edit section sorts the scenes extracted by the image extract section into groups by content so that each of the groups can be accessed separately.

9. An image processing apparatus according to claim 4 wherein,
the image edit section sorts the scenes extracted by the image extract section into groups by the time of recording so that each of the groups can be accessed separately.

10. An image processing apparatus according to claim 4 wherein,
images edited by the image edit section are recorded to the recording medium or an external recording medium.

11. An image pickup apparatus comprising:
an image pickup section that captures images of a subject and outputs the captured images;
a compression encoding section that encodes the captured images by a compression encoding method which uses motion vectors determined by utilization of inter-frame correlation;
a record playback section by which the captured images encoded by the compression encoding section are recorded to and retrieved from a recording medium;
a CPU; and
a memory having a program stored therein which operates the CPU to control the record playback section so as to retrieve captured images recorded on the recording medium, analyze motion vectors in the captured images, extract a part which contains at least a predetermined number of motion vectors whose mutual differences fall within a predetermined range, and record the extracted part on the recording medium as an edited image sequence.
